(19) United States
(12) Patent Application Publication
(10) Pub. No.: US 2019/0205744 A1
(43) Pub. Date: Jul. 4, 2019

(54) Distributed Architecture for Enhancing Artificial Neural Network

(71) Applicant: Micron Technology, Inc., Boise, ID (US)

(72) Inventors: Antonino Mondello, Messina (IT); Alberto Troia, Munich (DE)

(21) Appl. No.: 15/858,143

(22) Filed: Dec. 29, 2017

(51) Int. Cl. G06N 3/08; G06N 3/04; G05D 1/00; G05D 1/02

(52) U.S. Cl. CPC G06N 3/08; G06N 3/0454; G05D 1/0088; G05D 1/0221; G05D 1/0223; G05D 2201/0213; G05D 1/0242; G05D 1/0246; G05D 1/024; G05D 1/0255; G05D 1/0257; G05D 1/0287

(57) ABSTRACT

A centralized computer server initially storing a first artificial neural network (ANN) model. A typical vehicle in a population has the first ANN model initially installed therein to generate outputs from inputs generated by one or more sensors of the vehicle. The vehicle selects an input based on an output generated from the input using the first ANN model, and transmits the selected input to the centralized computer server as part of sensor data used by the server to further train the first ANN model using a supervised machine learning technique and to generate a second ANN model as replacement of the first ANN model previously deployed in the population.

### FIELD OF THE TECHNOLOGY

At least some embodiments disclosed herein relates to artificial neural network in general and more particularly, but not limited to, artificial neural network for vehicle control.

### BACKGROUND

Recent developments in the technological area of autonomous driving allow a computing system to operate, at least under some conditions, control elements of a vehicle without the assistance from a human operator of the vehicle.

For example, sensors (e.g., cameras and radars) can be installed on a vehicle to detect the conditions of the surroundings of the vehicle on a roadway. A computing system installed on the vehicle analyzes the sensor inputs to identify the conditions and generate control signals or commands for the autonomous adjustments of the direction and/or speed of the vehicle, without any input from a human operator of the vehicle.

Autonomous driving and/or advanced driver assistance system (ADAS) typically involves artificial neural network (ANN) for the identification of events and/or objects that are captured in sensor inputs.

In general, an artificial neural network (ANN) uses a network of neurons to process inputs to the network and to generate outputs from the network.

Each neuron m in the network receives a set of inputs pₖ, where k=1, 2, . . . , n. In general, some of the inputs to a neuron may be the outputs of certain neurons in the network; and some of the inputs to a neuron may be the inputs to the network as a whole. The input/output relations among the neurons in the network represent the neuron connectivity in the network.

Each neuron m has a bias bₘ, an activation function ƒₘ, and a set of synaptic weights wₘₖ for its inputs pₖ respectively, where k=1, 2, . . . , n. The activation function may be in the form of a step function, a linear function, a log-sigmoid function, etc. Different neurons in the network may have different activation functions.

Each neuron m generates a weighted sum sₘ of its inputs and its bias, where sₘ=bₘ+wₘ₁×p₁+wₘ₂×p₂+ . . . +wₘₙ×pₙ. The output aₘ of the neuron m is the activation function of the weighted sum, where aₘ=ƒₘ (sₘ).

The relations between the input(s) and the output(s) of an ANN in general are defined by an ANN model that includes the data representing the connectivity of the neurons in the network, as well as the bias bₘ, activation function ƒₘ, and synaptic weights wₘₖ of each neuron m. Using a given ANN model a computing device computes the output(s) of the network from a given set of inputs to the network.

For example, the inputs to an ANN network may be generated based on camera inputs; and the outputs from the ANN network may be the identification of an item, such as an event or an object.

For example, U.S. Pat. App. Pub. No. 2017/0293808, entitled “Vision-Based Rain Detection using Deep Learning”, discloses a method of using a camera installed on a vehicle to determine, via an ANN model, whether the vehicle in in rain or no rain weather.

For example, U.S. Pat. App. Pub. No. 2017/0242436, entitled “Road Construction Detection Systems and Methods”, discloses a method of detecting road construction using an ANN model.

For example, U.S. Pat. Nos. 9,672,734 and 9,245,188 discuss techniques for lane detection for human drivers and/or autonomous vehicle driving systems.

In general, an ANN may be trained using a supervised method where the synaptic weights are adjusted to minimize or reduce the error between known outputs resulted from respective inputs and computed outputs generated from applying the inputs to the ANN. Examples of supervised learning/training methods include reinforcement learning, and learning with error correction.

Alternatively or in combination, an ANN may be trained using an unsupervised method where the exact outputs resulted from a given set of inputs is not known a priori before the completion of the training. The ANN can be trained to classify an item into a plurality of categories, or data points into clusters.

Multiple training algorithms are typically employed for a sophisticated machine learning/training paradigm.

The disclosures of the above discussed patent documents are hereby incorporated herein by reference.

### BRIEF DESCRIPTION OF THE DRAWINGS

The embodiments are illustrated by way of example and not limitation in the figures of the accompanying drawings in which like references indicate similar elements.

FIG. 1 illustrates a system to improve an Artificial Neural Network (ANN) model according to one embodiment.

FIG. 2 shows an example of vehicles configured in the system FIG. 1 to improve an Artificial Neural Network (ANN) model according to one embodiment.

FIG. 3 shows operations to update an Artificial Neural Network (ANN) model according to one embodiment.

FIG. 4 shows a method to update an Artificial Neural Network (ANN) model according to one embodiment.

FIG. 5 shows a detailed method to select data for training an Artificial Neural Network (ANN) model according to one embodiment.

### DETAILED DESCRIPTION

At least some embodiments disclosed herein provide a distributed system for updating an Artificial Neural Network (ANN) model installed in vehicles, where a training dataset is constructed based on the outputs of the ANN model that are generated from sensor data collected by the vehicles during their real world services. Based on the characteristics of the outputs, the corresponding sensor inputs used to generate the outputs are selectively stored in the vehicles and/or transmitted from the vehicles to a centralized server, which performs further machine learning/training, using a supervised method and the selected sensor data, to generate an updated ANN model that can be subsequently loaded into the vehicles to replace their previously installed ANN model and to enhance the capabilities of the vehicles in processing future sensor data.

For example, when an ANN model is used by a vehicle to generate an output from a set of sensor data of the vehicle at an instance of service, the output can be examined to determine whether the output represents and/or indicates inaccuracy and/or incapability of the ANN model in processing the set of sensor data. If so, the set of sensor data is stored in the vehicle and/or transmitted from the vehicle to the centralized server to facilitate further machine learning/training to generate an updated ANN model such that when the updated ANN model is used, the vehicle can accurately process the set of sensor data and/or similar data.

For example, an ANN model can be applied to a set of sensor data capturing an event or object encountered by a vehicle on a roadway for the recognition of the event or object. If the ANN model has not being previously trained, or has not being sufficiently trained via machine learning, to recognize this particular types of events or objects, the ANN model may fail to positively label the event or object as one of known events or objects. In such a situation, the ANN model may produce an output that identify the event or object as unknown, or as one of several possible events or objects. When the ANN model recognizes the event or object as possibly being any of two or more known events or objects, the ANN model fails to generate a unique output and fails to produce an accurate recognition result. In such a situation, the ANN model is to be further trained, e.g., via a supervised machine learning technique, to properly and/or accurately process the sensor data for the recognition of the event or object, and/or similar events or objects, from sensor data generated in real world services.

In general, an ANN model trained to process input data in recognizing or classifying an item captured in input data, such as data associated with an event or an object, may encounter an unexpected item during its service time when the ANN model is being used in one of many devices, such as in vehicles having functions for autonomous driving and/or advanced driver assistance system (ADAS), in connected home devices having artificial intelligence (AI) functions, in industry 4.0 devices having AI functions for automation and data exchange in manufacturing, etc. Thus, the techniques discussed herein in connection with vehicles can also be used with other intelligent devices, such as those for connected homes, robots, manufacturing, etc.

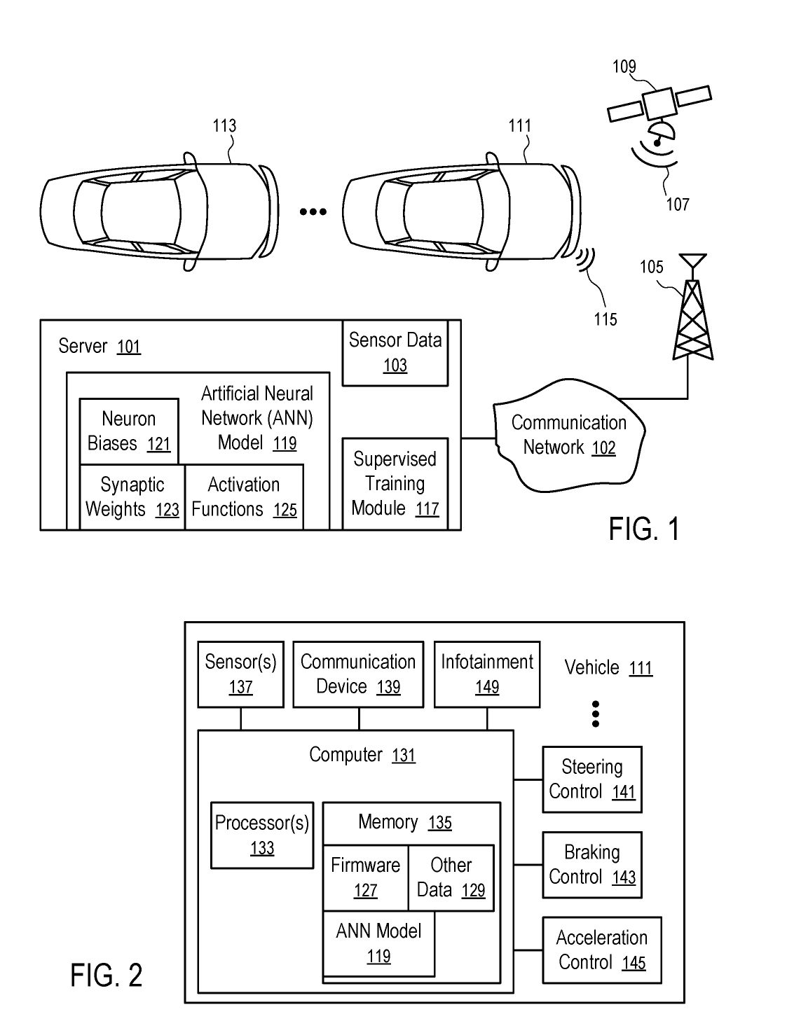

FIG. 1 illustrates a system to improve an Artificial Neural Network (ANN) model according to one embodiment.

The system of FIG. 1 includes a centralized server (101) in communication with a set of vehicles (111, . . . , 113) via a communications network (102)

The server (101) includes a supervised training module (117) to train, generate, and update an artificial neural network (ANN) model (119) that includes neuron biases (121), synaptic weights (123), and activation functions (125) of neurons in a network used for processing sensor data generated in the vehicles (111, . . . , 113).

Once the ANN model (119) is designed, trained and implemented, e.g., for autonomous driving and/or advanced driver assistance system, the ANN model (119) can be deployed on a population of vehicles (111, . . . , 113) for real world usage in their respective environments.

Typically, the vehicles (111, . . . , 113) have sensors, such as a visible light camera, an infrared camera, a LIDAR, a RADAR, a sonar, and/or a set of peripheral sensors. The sensors of the vehicles (111, . . . , 113) generate sensor inputs for the ANN model (119) in autonomous driving and/or advanced driver assistance system to generate operating instructions, such as steering, braking, accelerating, driving, alerts, emergency response, etc.

During the operations of the vehicles (111, . . . , 113) in their respective service environments, the vehicles (111, . . . , 113) encounter items, such as events or objects, that are captured in the sensor data. The ANN model (119) is used by the vehicles (111, . . . , 113) to provide the identifications of the items to facilitate the generation of commands for the operations of the vehicles (111, . . . , 113), such as for autonomous driving and/or for advanced driver assistance.

Some of the encountered items may be unexpected and thus not fully considered in the design, training and/or implementation of the ANN model (119). As a result, the ANN model (119) may identify the unexpected item as unknown, or fails to classify the item into a single known category.

A function of the vehicles (111, . . . , 113) for autonomous driving and/or advanced driver assistance may process such an unknown item according to a pre-programmed policy. For example, as a response to the detection of an unknown event or object, the vehicle (111) may be programmed to avoid the item, initiate a safe-mode response, alert a human operator to take control, request assistance from a human operator, place the vehicle in a safer situation by keeping a distance, and/or slow down for a stop, etc.

When an output, generated by using the ANN model (119) from a particular sensor input, identifies an unknown item (or classifies an item with an insufficient precision or confidence level), the vehicle (e.g., 111) is configured to store the particular sensor input that is responsible for the output and/or transmit the sensor input to the centralized server (101). The sensor input selected and transmitted back to the server (101) enriches the sensor data (103) for the training and updating of the ANN model (119) through a supervised machine learning technique implemented in the training model (117).

For example, a vehicle (111) may communicate, via a wireless connection (115) to an access point (or base station) (105), with the server (101) to submit the sensor input to enrich the sensor data (103) as an additional dataset for machine learning implemented using the supervised training module (117). The wireless connection (115) may be made via a wireless local area network, a cellular communications network, and/or a communication link (107) to a satellite (109) or a communication balloon.

Optionally, the sensor input stored in the vehicle (111) may be transferred to another computer for uploading to the centralized server (101). For example, the sensor input can be transferred to another computer via a memory device, such as a Universal Serial Bus (USB) drive, and/or via a wired computer connection, a Bluetooth or WiFi connection, a diagnosis tool, etc.

Optionally, the sensor inputs for different instances of unexpected items encountered by the vehicle (111) during its real world services can be stored in the vehicle (111) and bundled together for transmission in a batch mode to the server (101) at a suitable time, such as a time of regularly scheduled maintenance services, or a time when the vehicle (111) is parked at a location having access to internet.

Optionally, the sensor input can be transmitted (e.g., using a cellular communications network) in real time during the operation of the vehicle and/or during the processing of the instance of encountering the unexpected item.

Optionally, the vehicle (111) may also select other sensor inputs based on the processing of the autonomous driving and/or advanced driver assistance system. For example, when a vehicle (111) is determined to be in an unsafe or undesirable condition, the vehicle (111) may provide to the server (101) the sensor inputs recorded for a time period leading to the condition.

Optionally, the vehicle (111) may also select some sensor inputs randomly to enrich the sensor data (103) for the training and updating of the ANN model (119).

Periodically, the server (101) runs the supervised training module (117) to update the ANN model (119). The server (101) may use the sensor data (103) enhanced with the sensor inputs from the vehicle (111) and/or from similar vehicles (e.g., 113) that are operated in the same geographical region or in geographical regions having similar traffic conditions to generate a customized version of the ANN model (119) for the vehicle (111).

Optionally, the server (101) uses the sensor data (103) enhanced with the sensor inputs from a general population of vehicles (e.g., 111, 113) to generate an updated version of the ANN model (119) for the general population.

Since the updated version of the ANN model (119) is trained, via machine learning, using the sensor inputs associated with the previously unexpected or unrecognized items to recognize and/or classify with certainty and accuracy these items and/or similar items. Thus, the capability of the ANN model (119) is enhanced.

The updated ANN model (119) can be downloaded to the vehicles (e.g., 111) via the communications network (102), the access point (or base station) (105), and communication links (115 and/or 117) as an over-the-air update of the firmware/software of the vehicles (e.g., 111). Alternatively, the update may be performed at an auto dealership or an authorized auto repair shop.

Optionally, the vehicle (111) has a self-learning capability. After an extended period on the road, the vehicle (111) may generate a new set of synaptic weights (123), neuron biases (121), activation functions (125), and/or neuron connectivity for the ANN model (119) installed in the vehicle (111) using the sensor inputs it collected and stored in the vehicle (111), such as the sensor inputs capturing the unexpected, unknown, and/or unrecognized events or objects.

As an example, the centralized server (101) may be operated by a factory, a producer or maker of the vehicles (111, . . . , 113), or a vendor of the autonomous driving and/or advanced driver assistance system for vehicles (111, . . . , 113).

FIG. 2 shows an example of vehicles configured in the system FIG. 1 to improve an Artificial Neural Network (ANN) model according to one embodiment.

The vehicle (111) of FIG. 2 includes an infotainment system (149), a communication device (139), one or more sensors (137), and a computer (131) that is connected to some controls of the vehicle (111), such as a steering control (141) for the direction of the vehicle (111), a braking control (143) for stopping of the vehicle (111), an acceleration control (145) for the speed of the vehicle (111), etc.

The computer (131) of the vehicle (111) includes one or more processors (133), memory (135) storing firmware (or software) (127), the ANN model (119) (e.g., as illustrated in FIG. 1), and other data (129).

The one or more sensors (137) may include a visible light camera, an infrared camera, a LIDAR, RADAR, or sonar system, and/or peripheral sensors, which are configured to provide sensor input to the computer (131). A module of the firmware (or software) (127) executed in the processor(s) (133) applies the sensor input to an ANN defined by the model (119) to generate an output that identifies or classifies an event or object captured in the sensor input, such as an image or video clip.

The identification or classification of the event or object generated by the ANN model (119) can be used by an autonomous driving module of the firmware (or software) (127), or an advanced driver assistance system, to generate a response. The response may be a command to activate and/or adjust one of the vehicle controls (141, 143, and 145).

Optionally, the identification or classification of the event or object is presented to an occupant of the vehicle (111) via the infotainment system (149).

When the identification or classification of the current event or object is to be improved (e.g., when the event or object is identified as unknown, or identified as one of multiple possible events or objects, or identified as being an event or object with a confidence level below a threshold), the computer (131) selects the sensor input (e.g., the image or video clip, or data derived for the ANN from the image or video clip) for storage in the memory (135)). Subsequently, or in real time, the computer (131) transmits the selected sensor input to the server (101) illustrated in FIG. 1 using the communication device (139).

The server (101) stores the received sensor input as part of the sensor data (103) for the subsequent further training or updating of the ANN model (119) using the supervised training module (117).

When an updated version of the ANN model (119) is available in the server (101), the vehicle (111) may use the communication device (139) to download the updated ANN model (119) for installation in the memory (135) and/or for the replacement of the previously installed ANN model (119).

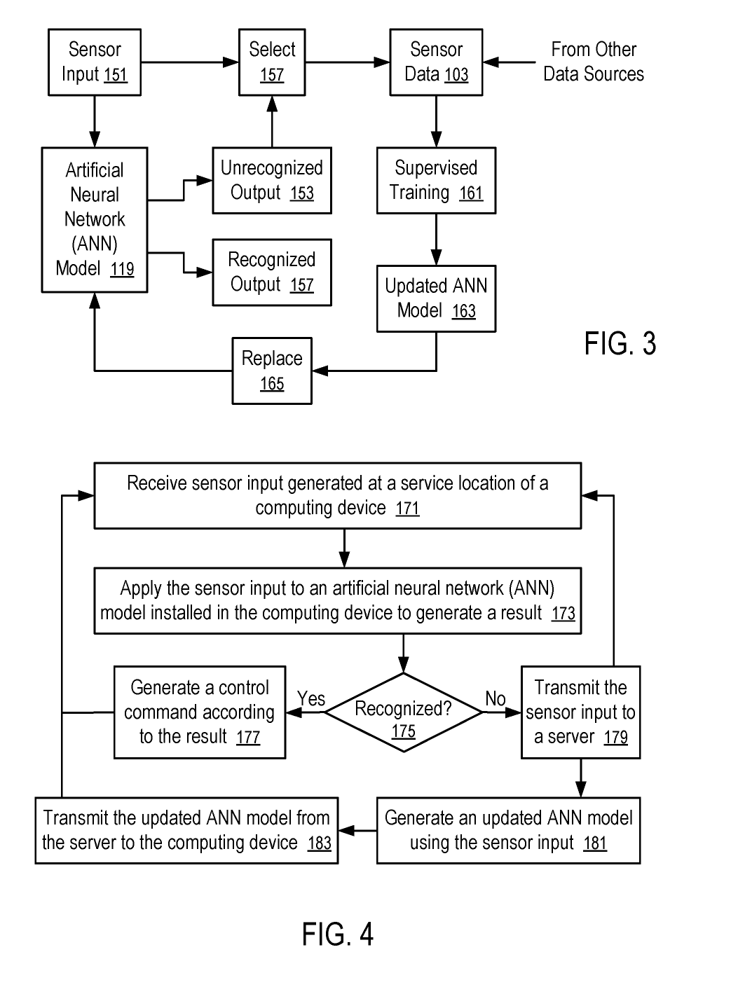

FIG. 3 shows operations to update an Artificial Neural Network (ANN) model according to one embodiment. For example, the operations of FIG. 3 can be performed in the system of FIG. 1 having a vehicle (111) of FIG. 2.

In FIG. 3, a sensor input (151) is obtained from one or more sensors, such as the sensor(s) (137) installed in the vehicle (111) of FIG. 2. For example, the sensor input (151) is based on an image or a video captured using a camera sensing visible lights and/or infrared lights, or a LIDAR, RADAR, or sonar system. For example, the image or video shows an event or an object in the surrounding of the vehicle (111) of FIG. 2 on a roadway.

The sensor input (151) is applied to the ANN model (119) installed in a computing device, such as the computer (131) of the vehicle (111) of FIG. 2, to generate an output, which may be a recognized output (157) or an unrecognized output (153). Based on the sensor input (151) causing the ANN model to generate the unrecognized output (153), the selection (157) of the corresponding sensor input (151) is performed, such that the sensor input (151) responsible for the generation of the unrecognized output (153) is selected as part of the sensor data (103)

The selected sensor input (151) is added to the sensor data (103) to form a training dataset for the supervised training (161) of the updated ANN model (163).

Optionally, the sensor data (103) may include contributions from other data sources, such as selected sensor input from other vehicles (e.g., 113).

Preferably, the sensor data (103) is collected at a centralized server (e.g., 101 illustrated in FIG. 1) which performs the supervised training to generate the updated ANN model (163) (e.g., using a supervised machine learning technique implemented in the supervised training module (117) illustrated in FIG. 1).

The updated ANN model (163) is to replace (165) the previously installed ANN model (119) in the corresponding computing device, such as the computer (131) of the vehicle (111) of FIG. 2. For example, when the computer (131) of the vehicle (111) uses the previously installed ANN model (119), the computer (131) generates the unrecognized output (153) from the sensor input (151) (or similar inputs). When the computer (131) of the vehicle (111) uses the updated ANN model (163), the computer (131) is capability of generating the recognized output (157) from the sensor input (151) (or similar inputs). Thus, the capability of the vehicle (111) is improved by storing and using the updated ANN model (163) in the memory (135) of its computer (131).

The operations of FIG. 3 can also be performed in other intelligent systems that use ANN models in a population of computing devices at various service locations to process sensor data, such as a connected home system with intelligent devices powered by ANN models and sensors, or an industry 4.0 system with devices powered by ANN models and sensors.

FIG. 4 shows a method to update an Artificial Neural Network (ANN) model according to one embodiment. For example, the method of FIG. 4 can be performed at least in part in the vehicle (111) of FIG. 2 in the system of FIG. 1. The method of FIG. 4 can also be performed in another ANN powered device, such as a connected home device or an industry 4.0 device, in a distributed system similar to that illustrated in FIG.

The method of FIG. 4 includes: receiving (171) sensor input (151) generated at a service location of a computing device (e.g., 131); applying (173) the sensor input (151) to an artificial neural network (ANN) model (119) installed in the computing device (e.g., 131) to generate a result (e.g., 153 or 157); determining (175) whether the result is a recognized result (e.g., 157) or an unrecognized result (e.g., 153).

If it is determined (175) that the result is a recognized result (e.g., 157), the method of FIG. 4 further includes generating (177) a control command according to the result (without transmitting the sensor input to a centralized server (e.g., 101)); otherwise, the computing device (e.g., 131) transmits (179) the sensor input (151) to the centralized server (e.g., 101) to cause the centralized server (181) to generate (181) an updated ANN model (163) using the sensor input (151) at the centralized server (e.g., 101). The updated ANN model (163) is transmitted (183) from the server to the computing device (e.g. 131) to update its ANN capability.

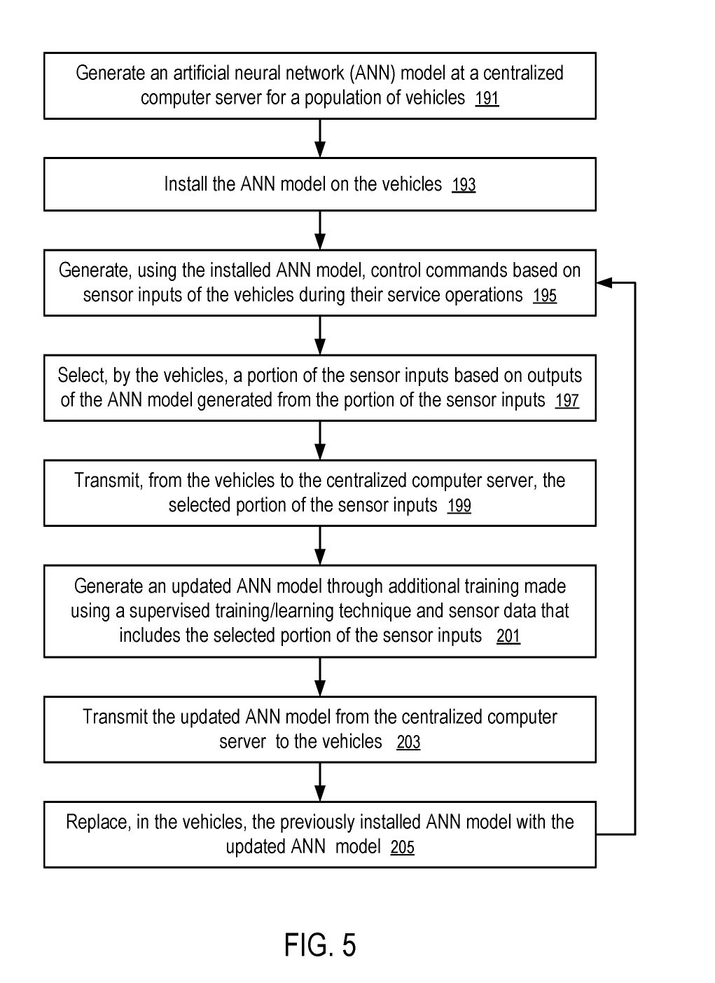

FIG. 5 shows a detailed method to select data for training an Artificial Neural Network (ANN) model according to one embodiment. For example, the method of FIG. 5 can be performed in the system of FIG. 1 for vehicles illustrated in FIG. 2 using the techniques of FIG. 3 and/or FIG. 4.

The method of FIG. 5 includes: generating (191) an artificial neural network (ANN) model (119) at a centralized computer server (101) for a population of vehicles (111, . . . , 113); installing (193) the ANN model (119) on the vehicles (111, . . . , 113); generating (195), using the installed ANN model (119), control commands based on sensor inputs (151) of the vehicles (111, . . . , 113) during their service operations; selecting (197), by the vehicles (111, . . . , 113), a portion of the sensor inputs (e.g., 151) based on the outputs (e.g., 153) of the installed ANN model (119) that are generated from the portion of the sensor inputs (e.g., 151); transmitting (199), from the vehicles (111, . . . , 113) to the centralized computer server (101), the selected portion of the sensor inputs (e.g., 151) as the sensor data (103) for further training through supervised machine learning; generating (201) an updated ANN model (163) through additional training (161) made using a supervised training/learning technique and using the sensor data (103) that includes the selected portion of the sensor inputs (151); transmitting (203) the updated ANN model (163) from the centralized computer server (101) to the vehicles (111, . . . , 113); and replacing (205), in the vehicles (111, . . . , 113), the previously installed ANN model (119) with the updated ANN model (163).

For example, in the method of FIG. 5, the outputs of the ANN model (119 or 163) can be used to control (e.g., 141, 143, 145) the acceleration of a vehicle (e.g., 111), the speed of the vehicle (111), and/or the direction of the vehicle (111), during autonomous driving or provision of advanced driver assistance.

Typically, when the updated ANN model (153) is generated, at least a portion of the synaptic weights (123) of some of the neurons in the network is updated. The update may also adjust some neuron biases (121) and/or change the activation functions (125) of some neurons. In some instances, additional neurons may be added in the network. In other instances, some neurons may be removed from the network.

In the method of FIG. 5, the portion of the sensor inputs (e.g., 151) can be selected (197) based on one or more characteristics of the outputs that cause the selection of the corresponding sensor inputs (e.g., 151) that generate the corresponding outputs.

For example, a sensor input (151) may be an image or video that captures an event and/or an object using a camera that images using lights visible to human eyes, or a camera that images using infrared lights, or a sonar, radar, or lidar system. The sensor input (151) can be selected (157,197) in response to the output (e.g., 153), generated from the respective selected sensor input (151), identifying an unknown item, identifying an item unexpected in the development of the initial artificial neural network model (119), and/or identifying an item, such as an event or an object captured in the input (151), as being one of two or more possible candidates.

For example, the sensor input (151) can be selected (197) for generating an output (153) that has the characteristic of lack of knowledge about an item captured in the sensor input (151), lack of a definite classification of the item in a plurality of known categories, lack of a predetermined identification of the item, having below a threshold an accuracy in the identification or classification of the item, and/or having below a threshold a confidence level in recognizing of the item, etc.

In some instances, the updated ANN model (163) is customized for a particular vehicle (111) based on the sensor inputs (151) selected by the particular vehicle (111). In other instances, the updated ANN model (163) is generic for using sensor inputs (e.g., 151) selected by the population of the vehicles (111, . . . , 113) in service.

The transmitting (199) of the selected portions may be performed in real time by the respective vehicles during their processing of the outputs from the currently installed ANN model (119). Alternatively, each vehicle (e.g., 111) may save a set of selected sensor inputs (e.g., 151) and schedule their transmission at a convenient time, such as during a maintenance or repair service at a dealership, at a night time while being parked at a location having access to internet, etc.

The present disclosure includes methods and apparatuses which perform these methods, including data processing systems which perform these methods, and computer readable media containing instructions which when executed on data processing systems cause the systems to perform these methods.

Each of the server (101) and the computer (131) of a vehicle (111, . . . , or 113) can be implemented as one or more data processing systems.

A typical data processing system may include includes an inter-connect (e.g., bus and system core logic), which interconnects a microprocessor(s) and memory. The microprocessor is typically coupled to cache memory.

The inter-connect interconnects the microprocessor(s) and the memory together and also interconnects them to input/output (I/O) device(s) via I/O controller(s). I/O devices may include a display device and/or peripheral devices, such as mice, keyboards, modems, network interfaces, printers, scanners, video cameras and other devices known in the art. In one embodiment, when the data processing system is a server system, some of the I/O devices, such as printers, scanners, mice, and/or keyboards, are optional.

The inter-connect can include one or more buses connected to one another through various bridges, controllers and/or adapters. In one embodiment the I/O controllers include a USB (Universal Serial Bus) adapter for controlling USB peripherals, and/or an IEEE-1394 bus adapter for controlling IEEE-1394 peripherals.

The memory may include one or more of: ROM (Read Only Memory), volatile RAM (Random Access Memory), and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In the present disclosure, some functions and operations are described as being performed by or caused by software code to simplify description. However, such expressions are also used to specify that the functions result from execution of the code/instructions by a processor, such as a microprocessor.

Alternatively, or in combination, the functions and operations as described here can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While one embodiment can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs.” The computer programs typically include one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to non-transitory, recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROM), Digital Versatile Disks (DVDs), etc.), among others. The computer-readable media may store the instructions.

The instructions may also be embodied in digital and analog communication links for electrical, optical, acoustical or other forms of propagated signals, such as carrier waves, infrared signals, digital signals, etc. However, propagated signals, such as carrier waves, infrared signals, digital signals, etc. are not tangible machine readable medium and are not configured to store instructions.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

The above description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A system, comprising:
a centralized computer server initially storing a first artificial neural network model having data identifying:
biases of neurons in a network of the neurons;
synaptic weights of the neurons; and
activation functions of the neurons; and
a population of vehicles, each respective vehicle in the population having:
the first artificial neural network model initially installed in the vehicle;
at least one sensor that generates inputs for the first artificial neural network model during operations of the vehicle; and
a computing device programmed to process the inputs using the first artificial neural network model;
wherein the computing device is configured to select an input based on an output of the first artificial neural network model generated from the input;
wherein the input is transmitted to and stored in the centralized computer server as part of sensor data;
wherein the centralized computer server further trains, using the sensor data that includes the input selected by the vehicle, the first artificial neural network model to generate a second artificial neural network model; and
wherein the second artificial neural network model is transmitted from the centralized computer server to the vehicle to replace the first artificial neural network model initially installed in the vehicle.

2. The system of claim 1, wherein the computing device controls, based on the output, one of:
acceleration of the vehicle;
speed of the vehicle; and
direction of the vehicle.

3. The system of claim 1, wherein the second artificial neural network model includes data identifying updated synaptic weights of at least a portion of the neurons.

4. The system of claim 3, wherein the computing device selects the input in response to the output identifying an unknown item.

5. The system of claim 3, wherein the computing device selects the input in response to the output identifying an item unexpected in development of the first artificial neural network model.

6. The system of claim 3, wherein the computing device selects the input in response to the output identifying an item, captured in the input, as being one of two or more candidates.

7. The system of claim 3, wherein the computing device selects the input based on a characteristic of the output; and wherein the input captures an item encountered by the vehicle during operation.

8. The system of claim 7, wherein the characteristic is one of:
lack of knowledge about the item;
lack of classification of the item into a plurality of known categories;
lack of an identification of the item;
having an accuracy in identification of the item below a threshold; and
having a confidence level in recognizing of the item below a threshold.

9. The system of claim 8, wherein the at least one sensor includes at least one of:
a camera that images using lights visible to human eyes;
a camera that images using infrared lights;
a sonar;
a radar; and
a lidar.

10. The system of claim 9, wherein the input is one of: an image and a video clip.

11. The system of claim 9, wherein the item is one of: an event and an object.

12. The system of claim 1, wherein the sensor data includes inputs selected by and transmitted from a plurality of vehicles in the population.

13. The system of claim 1, wherein the second artificial neural network model is customized for the vehicle.

14. A method, comprising:
storing initially, in a computing device at a service location remote from a centralized computer server, a first artificial neural network model having data identifying:
biases of neurons in a network of the neurons;
synaptic weights of the neurons; and
activation functions of the neurons; and
receiving, from at least one sensor coupled to the computing device at the service location, inputs for the first artificial neural network model;
processing, by the computing device, the inputs using the first artificial neural network model to generate outputs;
selecting, by the computing device, an input based on an output of the first artificial neural network model generated from the input;
transmitting the input, from the computing device to the centralized computer server, as part of sensor data stored in the centralized computer server, wherein the centralized computer server further trains, using the sensor data that includes the input selected by the vehicle, the first artificial neural network model to generate a second artificial neural network model; and
downloading, by the computing device from the centralized computer server, the second artificial neural network model to replace the first artificial neural network model initially stored in the vehicle.

15. The method of claim 14, further comprising:
generating, by the computing device based on the outputs, commands to control at least one of:
acceleration of a vehicle;
speed of the vehicle; and
direction of the vehicle.

16. The method of claim 15, wherein the at least one sensor and the computing device are installed on the vehicle.

17. The method of claim 16, wherein the transmitting of the input is in real time during processing of the output at the service location.

18. A non-transitory computer storage medium storing instructions which when executed by a centralized computer server causes the server to perform a method, the method comprising:
storing initially a first artificial neural network model having data identifying:
biases of neurons in a network of the neurons;
synaptic weights of the neurons; and
activation functions of the neurons; and
communicating, via a communications network, a population of computing devices, each computing device in the population having:
the first artificial neural network model initially installed in the computing device;
at least one sensor that generates inputs for the first artificial neural network model during operations of the computing device;
wherein the computing device is configured to:
process the inputs using the first artificial neural network model to generate outputs;
select an input based on an output of the first artificial neural network model generated from the input; and
transmit the input to the centralized computer server;
storing the input in the centralized computer server as part of sensor data;
training, using the sensor data that includes the input selected by the computing device, the first artificial neural network model to generate a second artificial neural network model; and
transmitting, from the centralized computer server to the computing device, the second artificial neural network model to replace the first artificial neural network model initially installed in the computing device.

19. The non-transitory computer storage medium of claim 18, wherein the training is performed using a supervised training or learning technique.

20. The non-transitory computer storage medium of claim 18, wherein the outputs control at least one of:
acceleration of a vehicle;
speed of the vehicle; and
direction of the vehicle.
